(19) United States
(12) Patent Application Publication
(10) Pub. No.: US 2026/0369609 A1
(43) Pub. Date: Nov. 19, 2026

(54) SECONDARY BATTERY ELECTRODE BINDERS

(71) Applicant: SYENSQO SPECIALTY POLYMERS ITALY, S.p.A., Bollate (Milano) (IT)

(72) Inventors: Ségolène Brusseau, Bollate (IT); Julio A. Abusleme, Bollate (IT); Rosita Lissette Pena Cabrera, Bollate (IT); Michele Fiore, Bollate (IT); Andrea Vittorio Oriani, Bollate (IT); Roberto Biancardi, Bollate (IT)

(73) Assignee: SYENSQO SPECIALTY POLYMERS ITALY, S.p.A., Bollate (Milano) (IT)

(21) Appl. No.: 19/122,690

(22) PCT Filed: Oct. 11, 2023
(86) PCT No.: PCT/EP2023/078154

§ 371 Date: Apr. 18, 2025

(30) Foreign Application Priority Data
Oct. 18, 2022 (EP) 22202255.0
Feb. 17, 2023 (EP) 23157209.0

(51) Int. Cl. H01M 4/62; C08F 2/38; C08F 14/22; H01M 4/04; H01M 4/58

(52) U.S. Cl. CPC H01M 4/623; C08F 2/38; C08F 14/22; H01M 4/0404; H01M 4/043; H01M 4/5825

(57) ABSTRACT

The present invention pertains to vinylidene fluoride polymers containing ethyl carbonate end groups and to their use as binders for electrodes in secondary batteries.

### CROSS REFERENCE TO PREVIOUS APPLICATIONS

This application claims priority to European application No. 22202255.0 filed on 18 Oct. 2022, and to European application No. 23157209.0 filed on 17 Feb. 2023, the whole content of this application being incorporated herein by reference for all purposes.

### TECHNICAL FIELD

The present invention pertains to vinylidene fluoride polymers use as binder for electrodes in secondary batteries.

### BACKGROUND ART

Fluoropolymers are known in the art to be suitable as binders for the manufacture of electrodes for use in electrochemical devices such as secondary batteries.

In general, increasing the fluoropolymers molecular weight is known to increase the performances of articles made from these materials, in particular in terms of mechanical properties and in terms of adhesion of the electrodes to the current collector.

However, increasing the fluoropolymers molecular weight will increase the viscosity of the electrode-forming formulation including the same, also called electrode slurry, making much more difficult the handling and the coating process in the fabrication of electrodes.

CN110183562 discloses the preparation of a high molecular weight PVDF by using di-isopropyl peroxydicarbonate as initiator. The resulting PVDF is characterized by a high crystallinity, which makes the electrode slurry compositions comprising the same useless for preparing electrodes. The high crystallinity PVDF is thus blended with VDF-based copolymers to obtain a polymer mixture suitable for use as electrode binder.

In the technical field of batteries, notably of sodium or lithium batteries, the problem of providing electrode binders characterized by very good adhesion that at the same time do not impact negatively on the fabrication process of the electrodes, such as by an increase of the slurry viscosity to produce the same, is felt.

### SUMMARY OF INVENTION

It has been found that certain vinylidene fluoride polymers are endowed with very good adhesion to metal substrates and can be used in the preparation of electrode-forming compositions having improved slurry viscosity at low shear rates.

It is thus an object of the invention a VDF-based polymer [polymer (F)] consisting of recurring units derived from VDF and, optionally, recurring units derived from at least one fluorinated comonomer (CF), different from VDF, said polymer (F) having intrinsic viscosity, measured in dimethylformamide at 25 °C, in the range of from 0.25 l/g to 0.60 l/g, more preferably from 0.30 l/g to 0.50 l/g where the polymer (F) is characterized by containing end groups of formula (I):

—(Rₐ)ₓ—O—CO—O—CH₂—CH₃ (I)
wherein Rₐ is a C₁-C₅ linear or branched hydrocarbon group and x is an integer selected from 1 and zero and
the end-groups of formula (I) are present in an amount of at least 0.2/10000 VDF units, preferably at least 1.0/10000 VDF units, and of at most 10/10000 VDF units.

A second object of the present invention pertains to an electrode-forming composition (C) comprising:
a) at least one electrode active material (AM);
b) at least one binder (B), wherein binder (B) comprises at least one polymer (F) as above defined; and
c) at least one solvent(S).

In another object, the present invention pertains to the use of the electrode-forming composition (C) in a process for the manufacture of an electrode [electrode (E)], said process comprising:
(I) providing a metal substrate having at least one surface;
(II) providing an electrode-forming composition (C) as above defined;
(III) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (III);
(V) submitting the dried assembly obtained in step (IV) to a compression step to obtain the electrode (E) of the invention.

In a further object, the present invention pertains to the electrode (E) obtainable by the process of the invention.

In still a further object, the present invention pertains to an electrochemical device comprising at least one electrode (E) of the present invention.

### DETAILED DESCRIPTION

By the term “VDF-based polymer” it is intended to denote a VDF homopolymer (PVDF) and VDF-based copolymers including recurring units derived from VDF and recurring units derived from at least one fluorinated comonomer (CF), different from VDF.

The VDF-based polymer (F) of the present invention does not include any hydrogenated monomer bearing polar groups.

By the term “recurring unit derived from vinylidene fluoride” (also generally indicated as vinylidene difluoride 1,1-difluoroethylene, VDF), it is intended to denote a recurring unit of formula CF₂═CH₂.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene, hexafluoroisobutylene, vinyl fluoride; 1,2-difluoroethylene and trifluoroethylene;
(b) perfluoroalkylethylenes of formula CH₂═CH—R_{f0}, wherein R_{f0} is a C₁-C₆ perfluoroalkyl group;
(c) chloro- and/or bromo- and/or iodo-C₂-C₆ fluoroolefins such as chlorotrifluoroethylene (CTFE).
(d) perfluoro (alkyl) vinyl ethers, such as perfluoro(methyl) vinyl ether (PMVE), perfluoro (ethyl) vinyl ether (PEVE) and perfluoro (propyl) vinyl ether (PPVE);
(e) perfluoro (1,3-dioxole); perfluoro (2,2-dimethyl-1,3-dioxole) (PDD).

In one preferred embodiment, polymer (F) is semi-crystalline and comprises from 0.1 to 20.0% by moles, preferably from 0.3 to 10.0% by moles, more preferably from 0.5 to 5.0% by moles of recurring units derived from said fluorinated comonomer (CF).

The polymer (F) can be an elastomer or a semi-crystalline polymer, preferably being a semi-crystalline polymer.

As used herein, the term “semi-crystalline” means a fluoropolymer that has, besides the glass transition temperature Tg, at least one crystalline melting point on DSC analysis. For the purposes of the present invention a semi-crystalline fluoropolymer is hereby intended to denote a fluoropolymer having a heat of fusion of from 10 to 90 J/g, preferably of from 30 to 80 J/g, more preferably of from 35 to 75 J/g, as measured according to ASTM D3418-08.

To the purpose of the invention, the term “elastomer” is intended to designate a true elastomer or a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

The polymer (F) of the present invention usually has a melting temperature (Tm) comprised in the range from 100 to 200 °C.

The polymer (F) of the present invention possesses a quasi-linear structure, with a very low amount of branching, which results in the insoluble fraction due to long branched chains being substantially negligible.

The polymer (F) of the present invention has in fact preferably a low fraction of insoluble components in standard polar aprotic solvents for VDF polymers, such as NMP. More preferably, solutions of polymer (F) in said standard polar aprotic solvents remain homogeneous and stable for several weeks, with substantially no insoluble residue.

Thanks to the low amount of insoluble components, the GPC and NMR analyses of polymer (F) are not affected, and there are no problems of reliability and reproducibility.

The melting temperature may be determined from a DSC curve obtained by differential scanning calorimetry (hereinafter, also referred to as DSC). In the case where the DSC curve shows a plurality of melting peaks (endothermic peaks), the melting temperature (Tm) is determined on the basis of the peak having the largest peak area.

It is understood that chain ends different from those above defined, defects or other impurity-type moieties might be comprised in the polymer (F) without these impairing its properties.

According to certain embodiments of the present invention, the polymer (F) is characterized by containing end groups of formula (I) as above defined, wherein x is zero.

According to other embodiments of the present invention, the polymer (F) is characterized by containing end groups of formula (I) as above defined, wherein x is 1, and Rₐ is a C₂-C₃ linear or branched alkyl radical, preferably C₃ linear or branched alkyl radicals.

According to other embodiments of the present invention, the polymer (F) is characterized by containing end groups of formula (I) as above defined, wherein x is zero and containing end groups of formula (I) wherein x is 1, and Rₐ is a C₂-C₃ linear or branched alkyl radical, preferably C₃ linear or branched alkyl radicals.

Polymer (F) is characterized by having a particle size distribution with a D50 value lower than 240 microns, measured using laser diffraction according to the ISO 13320.

D50 designates the particle diameter where half the population lies below this value and half lies above.

The Applicant has surprisingly found that a polymer (F) having a particle size distribution with a D50 value lower than 240 microns and an intrinsic viscosity, measured in dimethylformamide at 25°, in the range of from 0.25 l/g to 0.60 l/g, preferably from 0.30 l/g to 0.50 l/g, is particularly suitable for use in electrode-forming compositions having good adhesion to the current collector and optimal slurry viscosity.

Polymer (F) may be obtained by a process that comprises:
polymerizing the vinylidene fluoride (VDF) and optionally comonomer (CF), in an aqueous medium in the presence of a radical initiator system that introduces in the polymer chain end groups of formula (I).
maintaining the pressure in said reactor vessel exceeding the critical pressure of the vinylidene fluoride.

Suitable radical initiator systems include radical initiators such as di(ethyl) peroxydicarbonate and hydro-ethyl peroxydicarbonate.

The amount of radical initiator required for a polymerization is related to its activity and the temperature used for the polymerization. The total amount of radical initiator used is generally between 100 to 30000 ppm by weight on the total monomers weight used.

The radical initiator may be added in pure form, in solution, in suspension, or in emulsion, depending upon the initiator chosen.

The radical initiator systems may include a chain transfer agent (CTA).

Suitable CTA for the polymerization process for preparing the polymer (F) according to the present invention are those known in the art and are typically selected from the group consisting of short hydrocarbon chains like ethane and propane, esters such as ethyl acetate or diethyl maleate, diethylcarbonate. When an organic peroxide is used as the initiator, it could act also as effective CTA during the course of free radical polymerization.

When used, the CTA may be added all at once at the beginning of the reaction, or it may be added in portions, or continuously throughout the course of the reaction. The amount of CTA and its mode of addition depend on the desired properties of polymer (F) to be obtained.

Preferred CTA for use in the process of the present invention is diethylcarbonate.

In the process for preparing the polymer (F), pressure is maintained above critical pressure of vinylidene fluoride. Generally, the pressure is maintained at a value of more than 50 bars, preferably of more than 75 bars, even more preferably of more than 100 bars.

Preferably, the process of the invention is carried out at a temperature superior to the critical temperature of the VDF monomer, i.e. of at least 31 °C.

The polymer (F) is typically provided in form of powder according to the process described above.

Polymer (F) in the form of powder may be optionally further extruded to provide polymer (F) in the form of pellets.

The polymer (F) as above detailed may be used as binder for electrodes in secondary batteries.

A second object of the present invention pertains to an electrode-forming composition (C) comprising:
a) at least one electrode active material (AM);
b) at least one binder (B), wherein binder (B) comprises at least one polymer (F) as above defined; and
c) at least one solvent(S).

For the purpose of the present invention, the term “electro-active material (AM)” is intended to denote a compound that is able to incorporate or insert into its structure and substantially release therefrom alkaline or alkaline-earth metal ions during the charging phase and the discharging phase of an electrochemical device. The compound (AM) is preferably able to incorporate or insert and release lithium ions or sodium ions.

The nature of the compound (AM) in composition (C) depends on whether said composition is used in the manufacture of a positive electrode [electrode (Ep)] or a negative electrode [electrode (En)].

The electrode active material (AM) of positive electrodes is preferably a compound capable of intercalating lithium ions or sodium ions.

The conventional active materials (AM) at the positive electrode of sodium-ion batteries are generally selected from Na-based layered transition-metal oxides, Prussian blue analogs and polyanion-type materials.

In some embodiments the active materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is ⅔.

In some embodiments the active materials are Prussian blue analogs (PBA) of general formula AₓP[R(CN)₆]_{1-y□y}·mH₂O with A and alkali metal ion, P a N-coordinated transition metal ion, R a C-coordinated transition metal ion, □ a [R(CN)₆] vacancy, with 0≤x≤2 and 0≤y<1 such as Na_{0.81}Fe[Fe(CN)₆]_{0.79□0.21}, NaFe₂(CN)₆, Na_{1.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCo₁₋ₓFe(CN)₆ with 0≤x≤1 e.g. Na₂CoFe(CN)₆.

In some other embodiments the active materials are polyanion-type materials of general formula NaₓM_{y}(XO₄)ₙ (where X=S, P, Si, As, Mo and W and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x≤4 and M=V, Fe, Ni, Mn, Ti, Cr, Zr . . . ; X=P, S, Si, Se, Mo . . . )—with single transition metal type such as Na₃V₂(PO₄)₃ (NVP), Na₃Cr₂(PO₄)₃, Na₃Fe₂(PO₄)₃; —with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with ⅔≤x≤⅞ e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro sulfates such as NaMSO₄F (with M=Fe, Co, Ni); mixed phosphates/pyrophosphates of general formula Na₄M₃(PO₄)₂(P₂O₇) (with M representing transition metals) such as Na₄Mn₃(PO₄)₂(P₂O₇), Na₄CO₃(PO₄)₂ (P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCO₂₋ₓ(SO₄)₃, Na₂₊₂ₓMn₂₋ₓ(SO₄)₃ (where 0≤x≤1); silicates of general formula Na₂MSiO₄ (with M=Mn, Fe, Co and Ni).

In some preferred embodiments the active materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF).

The conventional active materials (AM) at the positive electrode of lithium-ion batteries may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material (AM) is a phosphate-based electro-active material of formula

LiₓA_{y}D₂PO₄,

wherein A is selected from the group consisting of Mn, Fe, Co, Ni and Cu; D is selected from the group consisting of Mg, Ca, Sr, Ba; x, y and z are numbers that satisfy the following relationships: 0<x<2, 0<y<1.5, 0≤z<1.5.

The A component is preferably Fe, Mn, and Ni, and particularly preferably Fe.

The D component is preferably Mg or Ca.

Examples of the compound having an olivine structure include lithium iron phosphate (LFP), lithium iron manganese phosphate (LMFP) and lithium manganese phosphate.

Further, as the positive electrode active material (AM), it is possible to use a material whose surface is partially or wholly covered with carbon in order to supplement the conductivity.

The amount of carbon coated is preferably 20 parts by weight or less, more preferably 10 parts by weight or less, still more preferably 5 parts by weight or less, based on 100 parts by weight of the positive electrode active material.

The compound having an olivine structure is present in composition (C) in an amount of 70% by mass or more, with respect to 100% by mass of the entire positive electrode active material (AM).

More preferably, it is 90% by mass or more, and most preferably, the positive electrode active material (AM) is composed only of a compound having an olivine structure.

Most preferably, the positive electrode active material (AM) consists only of lithium iron phosphate (LFP).

In the positive electrode composition of the present invention, the active material (AM) has an average particle size of 3 μm or less.

The average particle size (D50) of the compound having an olivine structure is more preferably in the range of from 0.01 to 1.8 μm.

The average particle size of the positive electrode active material can be measured by a particle size distribution meter for dynamic light scattering.

As the average particle size becomes smaller, the surface area becomes larger and the binder must be bound with a small amount of the binder, so that the flexibility of the binder is required.

By using a positive electrode active material containing a compound having an olivine structure having an average particle size of 3 μm or less, the electrical characteristics such as the output characteristics when the positive electrode composition for a secondary battery is used as the positive electrode of the battery are excellent.

In the case of forming a negative composite electrode (En) for a secondary battery, the compound (AM) may preferably comprise a carbon-based material and/or a silicon-based material.

In some embodiments, the carbon-based material may be, for example, graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in compound (AM), the at least one silicon-based compound is comprised in the compound (AM) in an amount ranging from 1 to 30% by weight, preferably from 5 to 20% by weight with respect to the total weight of the compound (AM).

The solvent(S) may preferably be an organic polar one, examples of which may include: N-methyl-2-pyrrolidone, N, N-dimethylformamide, N, N-dimethylacetamide, dimethylsulfoxide, hexamethylphosphamide, dioxane, tetrahydrofuran, tetramethylurea, triethyl phosphate, and trimethyl phosphate. These solvents may be used singly or in mixture of two or more species.

An optional conductive agent may be added in order to improve the conductivity of a resulting electrode (AM).

Examples thereof may include: carbonaceous materials, such as carbon black, graphite fine powder carbon nanotubes, graphene, or fiber, or fine powder or fibers of metals such as nickel or aluminum. The optional conductive agent is preferably carbon black. Carbon black is available, for example, under the brand names, Super P® or Ketjenblack®

The electro-forming composition (C) of the invention may further optionally include at least one conductive agent.

When present, the conductive agent is different from the carbon-based material described above.

In a preferred embodiment of the present invention, an electrode-forming composition (C) for use in the preparation of a positive electrode (Ep) is provided, said composition comprising:
a) at least one positive electrode active material (AM);
b) at least one binder (B), wherein binder (B) comprises at least one polymer (F) as above defined;
c) at least one solvent(S); and
d) at least one conductive agent, preferably selected from carbon black or graphite fine powder carbon nanotubes.

As said above, the polymer (F) of the present invention possesses a quasi-linear structure, and very low amount of insoluble fraction when dissolved in standard polar aprotic solvents such as NMP.

Thanks to the low amount of insoluble components, polymer (F) provides solutions in organic solvents, which are not detrimentally affected by the presence of insoluble residues, which are generally referred as “gels”, and are hence more adapted for use in formulating electrodes-forming compositions.

In another object, the present invention pertains to the use of the electrode-forming composition (C) for the manufacture of an electrode (E), said process comprising:
(I) providing a metal substrate having at least one surface;
(II) providing an electrode-forming composition (C) as above defined;
(III) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (III);
(V) submitting the dried assembly obtained in step (IV) to a compression step to obtain the electrode (E) of the invention.

In a further object, the present invention pertains to the electrode (E) obtainable by the process of the invention.

The Applicant has surprisingly found that the electrode (E) of the present invention shows outstanding adhesion of the binder to current collector.

The electrode (E) of the invention is thus particularly suitable for use in electrochemical devices, in particular in secondary batteries.

For the purpose of the present invention, the term “secondary battery” is intended to denote a rechargeable battery.

The secondary battery of the invention is preferably an alkaline or an alkaline-earth metal secondary battery.

The secondary battery of the invention is more preferably a sodium-ion or a lithium-ion secondary battery.

In still a further object, the present invention pertains to an electrochemical device comprising at least one electrode (E) of the present invention.

The electrochemical device according to the present invention, being preferably a secondary battery, comprises:
a positive electrode and a negative electrode,
   wherein at least one of the positive electrode and the negative electrode is the electrode (E) of the present invention.

In one preferred embodiment of the present invention it is provided an electrochemical device is a secondary battery comprising:
a positive electrode and a negative electrode,
   wherein the negative electrode is the electrode (E) according to the present invention.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL PART

### Determination of Intrinsic Viscosity of Polymer (F)

Intrinsic viscosity (η) [dl/g] was measured using the following equation on the basis of dropping time, at 25 °C, of a solution obtained by dissolving the polymer (F) in N, N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and Γ is an experimental factor, which for polymer (F) corresponds to 3.

### DSC Analysis

DSC analyses were carried out according to ASTM D 3418 standard; the melting point (T_{f2}) was determined at a heating rate of 10 °C/min.

### Determination of the Polar End-Groups

The amount of polar end groups of the polymers (F) arising from the ethyl chloroformate initiator precursor used in the polymerization process, was determined by ¹H-NMR, measuring the intensity of the H atoms of the CH₂ group (in bold in following formula) with respect to the total intensity of CH2 moieties of the polymer (F) backbone VDF monomer units:

CH₃—CH₂—OCOO—CH₂—CF₂—

The content of end groups was calculated by applying the following formula:

[EG]=(I_{EG}/I_{VDF})×10000

wherein:
[EG] is the content of the generic end-groups expressed as mols per 10000 VDF units,
I_{EG} is the intensity, normalized to one hydrogen, of the integral of the end-group [EG]
I_{VDF} is the intensity, normalized to one hydrogen, of the integrals of normal and reverse VDF recurring units.

About 20 mg of polymer were dissolved in 0.7 ml of hexadeuteroacetone. The ₁H-NMR spectrum, recorded at 60 °C, revealed the aforementioned CH₂ at 4.47 ppm whereas CH₂ signals from VDF recurring normal and reverse units resonated as broad peaks centered at 2.93 and 2.36 ppm respectively.

Similar NMR methods were applied to the determination of end groups deriving from the use of diethylcarbonate chain transfer agent (CH₃—CH₂—OCOO—CH₂—CH₂—, CH₃—CH₂—OCOO—CH(CH₃)—) and for the determination of —CF₂H and —CF₂CH₃ end groups, as known to people skilled in the art.

### Example 1: Preparation of Polymer F-1

In a 4 L reactor equipped with an impeller running at a speed of 650 rpm were introduced in sequence: 2376 g of demineralized water and 0.4 g of PEO (Alkox®-E45 from Alroko) per kg of total monomers and 0.5 g of hydroxypropyl methylcellulose (Methocel®-K100 from Dow) per kg of total monomers and 12.4 g of trisodium phosphate. The oxygen present in the reactor was removed with a sequence of vacuum and purge of nitrogen at a fixed temperature of 14 °C. This sequence was repeated 3 times.

Then, 10.16 g of hydrogen peroxide solution (from Brenntag) and 3.53 g of ethyl chloroformate (from Framochem) and 1.76 g of diethylcarbonate were introduced in the reactor.

After 15 minutes with the stirring speed of 880 rpm, 1176 g of VDF were introduced in the reactor. The reactor was then gradually heated until the set-point temperature of 35 °C was reached.

The pressure was kept constantly equal to 120 bars during the whole polymerization run by feeding water. A total of 657 g of water was charged to the reactor. After 162 minutes the polymerization was stopped by degassing the suspension until reaching atmospheric pressure.

The polymer was then collected by filtration and suspended against clean water in a stirred tank. After the washing treatment, the polymer was dried in an oven at 65 °C overnight. 882 g of dry powder were collected.

A polymer having an intrinsic viscosity of 0.316 l/g in DMF at 25 °C and a T₂f of 172.1 °C was obtained.

The polymer contained 1.7/10000 VDF units of end-group CH₃CH₂—OCOO—: 0.7/10000 VDF units derived from the ethyl chloroformate initiator precursor and 1.0/10000 VDF units derived from diethylcarbonate.

In addition, the presence of 2.3/10000 VDF units of —CF₂H and 1.4/10000 VDF units of —CF₂CH₃ end-groups was determined.

### Example 2: Preparation of Polymer F-2

In a 80 l reactor equipped with an impeller running at a speed of 250 rpm were introduced in sequence: 52.4 Kg of demineralized water and 0.4 g of hydroxypropyl methylcellulose (Methocel®-K100 from Dow) per kg of VDF. The oxygen present in the reactor was removed with a sequence of vacuum and purge of nitrogen at a fixed temperature of 20 °C. This sequence was repeated 3 times.

Then, 41.38 g of a solution of the initiator t-amylperpivalate (from United Initiators) in isododecane (75%) and 250.02 g of diethylcarbonate were introduced in the reactor. Immediately after, the stirring speed is brought to 300 rpm and 22.99 Kg g of VDF were added to the reactor. The reactor was then gradually heated until the set point temperature of 52 °C was reached. The pressure was kept constantly equal to 120 bars during the whole polymerization run by VDF. A total of 11.49 Kg of VDF were charged and no more VDF was charged. Then the temperature was brought to 65 °C and then after a total of 169 minutes the reaction was stopped by degassing the suspension until reaching atmospheric pressure.

The polymer was then collected by filtration and suspended against clean water in a stirred tank. After the washing treatment, the polymer was dried in an oven at 65 °C overnight. 29.94 Kg of dry powder were collected.

Polymer A: VDF homopolymer having an intrinsic viscosity of 0.271 l/g in DMF at 25 °C and a T₂f of 170.2 °C.

The polymer contained 2.2/10000 VDF units of end-group CH₃CH₂—OCOO derived from diethylcarbonate, 0.6/10000 VDF units of —C(CH₃)₃ from the initiator, 4.5/10000 VDF units of —CF₂H and 2.4/10000 VDF units of —CF₂CH₃ end-groups

General Preparation of the Electrodes with NMC811 Active Material

The positive electrodes having final composition of 98% by weight of NMC811 (Cosmo Advanced Materials & Technology, d50=10.28 μm), 1.1% by weight of polymer, 0.9% by weight of conductive additive were prepared as follows.

The slurry components were added to the mixing cup in the following order: 33.6 g of a multi-walled carbon nanotubes dispersion at solid content of 4.1% by weight, 21.1 g of 8% by weight solution of a polymer in NMP, 150 g of NMC, 7.9 g of NMP.

The mixture was then mixed using a high speed disk impeller at 500 rpm for 5 minutes, followed by 75 minutes at 1900 rpm.

Positive electrodes were obtained by casting the as obtained dispersion on 15 μm thick Aluminum foil with doctor blade and drying the as coated layers in a vacuum oven at temperature of 90 °C for about 50 minutes. The thickness of the dried coating layers was about 150 μm.

### Example 3: Adhesion and Slurry Viscosity

The polymers of examples 1 and 2 have been used as binders and the electrode compositions have been produced according to the procedure shown above.

The slurry viscosity of the compositions as above defined was measured with an AntonPaar Rheolab QC using a Concentric cylinder setup (Measuring Cup: C-CC27/QC-LTD Bob: CC27/P6) with peltier temperature control at 25 °C. Steady state viscosities were measured from shear rate of 0.1 to 1000 1/s.

Adhesion Peeling Force between Aluminium foil and Electrode was measured as follows:
180° peeling tests were performed following the setup described in the standard ASTM D903 at a speed of 300 mm/min at 20 °C in order to evaluate the adhesion of the dried coating layer as above defined to the Aluminium foil.

The values of slurry viscosity and adhesion are shown in Table 1.

TABLE 1

| | IV | Adhesion | Slurry Viscosity, | End groups |
|---|---|---|---|---|
| Polymer | [l/g] | [N/m] | (mPa*s) @ (10/s) | of formula (I) |
| F-1 | 0.316 | 21 | 3386 | 1.7 |
| F-2 | 0.271 | 15 | 2642 | 2.2 |

General Preparation of the Electrodes with LFP Active Material

The positive electrodes having final composition of 95.75% by weight of LFP (Phostech Lithium, d50=0.5 μm), 3.5% by weight of polymer, 0.75% by weight of conductive additive were prepared as follows.

A first dispersion was prepared by pre-mixing for 10 minutes in a centrifugal mixer 34.3 g of an 8% by weight solution of a polymer in NMP, 75.07 g of LFP, 14.7 g of graphite fine powder carbon nanotubes pre-dispersed in NMP at 4% by weight and 15.93 g of NMP.

The mixture was then mixed using a high speed butterfly type impeller at 1500 rpm for 50 minutes. Additional 5.2 g of NMP were subsequently added to the dispersion, which was further mixed centrifugal mixer for 5 min. Positive electrodes were obtained by casting the as obtained compositions on 15 μm thick Al foil with doctor blade and drying the as coated layers in a vacuum oven at temperature of 90 °C for about 50 minutes. The thickness of the dried coating layers was about 100 μm.

### Example 4: Adhesion and Slurry Viscosity

The polymers of examples 1 and 2 have been used as binders and the electrode compositions have been produced according to the procedure shown above. The values of slurry viscosity and adhesion, measured as above defined, are shown in Table 2.

TABLE 2

| | IV | Adhesion | Slurry Viscosity, | End groups |
|---|---|---|---|---|
| Polymer | [l/g] | [N/m] | (mPa*s) @ (10/s) | of formula (I) |
| F-1 | 0.316 | 4.79 | 13106 | 1.7 |
| F-2 | 0.271 | 2.53 | 8788 | 2.2 |

It is known to the person skilled in the art that the adhesion values of the binder to current collectors are greatly influenced by the particle size of the active material used in the preparation of the electrode; thus, with the same percentage amount of active material in the electrode, the use of active material having different particle size has a remarkable effect on the adhesion values.

Independently from the above, the results in Table 1 and Table 2 show that the polymers of the present invention are well performing leading to a good adhesion to the current collector.

1. A VDF-based polymer [polymer (F)] consisting of recurring units derived from VDF, optionally including recurring units derived from at least one fluorinated comonomer (CF), different from VDF, said polymer (F) having intrinsic viscosity, measured in dimethylformamide at 25 °C as determined according to the method reported in the description, in the range of from 0.25 l/g to 0.60 l/g,
where the polymer (F) is characterized by containing end groups of formula (I):
—(Rₐ)ₓ—O—CO—O—CH₂—CH₃ (I)
wherein Rₐ is a C₁-C₅ linear or branched hydrocarbon group and x is an integer selected from 1 and zero and
the end-groups of formula (I) are present in an amount of at least 0.2/10000 VDF units, and of at most 10/10000 VDF units, as determined according to the method reported in the description, and
said polymer (F) being characterized by having a particle size distribution with a D50 value lower than 240 microns, measured using laser diffraction according to the ISO 13320.

2. The polymer (F) according to claim 1, which is a VDF homopolymer.

3. The polymer (F) according to claim 1, which is a VDF-based copolymer comprising including recurring units derived from VDF and recurring units derived from at least one fluorinated comonomer (CF), different from VDF.

4. The polymer (F) according to claim 1, wherein the fluorinated comonomer (CF) is selected from the group consisting of:
a) C₂-C₈ fluoro- and/or perfluoroolefins;
b) perfluoroalkylethylenes of formula CH₂═CH—R_{f0}, wherein R_{f0} is a C₁-C₆ perfluoroalkyl group;
c) chloro- and/or bromo- and/or iodo-C₂-C₆ fluoroolefins;
d) perfluoro(alkyl)vinyl ethers; and
e) perfluoro(1,3-dioxole); perfluoro(2,2-dimethyl-1,3-dioxole) (PDD).

5. The polymer (F) according to claim 4, wherein polymer (F) comprises from 0.1 to 20.0% by moles of recurring units derived from said fluorinated comonomer (CF).

6. The polymer (F) according to claim 1 that contains end groups of formula (I) wherein x is zero and/or end groups of formula (I) wherein x is 1, and Rₐ is a C₂-C₃ linear or branched alkyl radical.

7. A process for preparing the polymer (F) according to claim 1, said process comprising:
polymerizing vinylidene fluoride (VDF) monomer, and optionally comonomer (CF), in an aqueous medium in the presence of a radical initiator system that introduces in the polymer chain end groups of formula (I), and
maintaining the pressure in the reactor vessel exceeding the critical pressure of the vinylidene fluoride.

8. The process according to claim 7, wherein the radical initiator system includes radical initiators di(ethyl) peroxydicarbonate and hydro-ethyl peroxydicarbonate.

9. The process according to claim 8, wherein the radical initiator system includes a chain transfer agent (CTA).

10. An electrode-forming composition (C) comprising:
a) at least one electrode active material (AM);
b) at least one binder (B), wherein binder (B) comprises at least one polymer (F) according to claim 1; and
c) at least one solvent(S).

11. The electrode-forming composition (C) according to claim 10,
wherein the at least one electrode active material (AM) is lithium iron phosphate (LFP).

12. A process for the manufacture of an electrode [electrode (E)], said process comprising:
(I) providing a metal substrate having at least one surface;
(II) providing an electrode-forming composition (C) according to claim 10;
(III) applying the composition (C) provided in step (II) onto the at least one surface of the metal substrate provided in step (I), thereby providing an assembly comprising a metal substrate coated with said composition (C) onto the at least one surface;
(IV) drying the assembly provided in step (III); and
(V) submitting the dried assembly obtained in step (IV) to a compression step to obtain the electrode (E).

13. An electrode (E) obtained by the process of claim 12.

14. An electrochemical device comprising at least one electrode (E) according to claim 13.
